(19) United States
(12) Patent Application Publication
(10) Pub. No.: US 2025/0305856 A1
(43) Pub. Date: Oct. 2, 2025

(54) OPTICAL FIBER SENSING SYSTEM AND OPTICAL FIBER SENSING METHOD

(71) Applicant: NIPPON TELEGRAPH AND TELEPHONE CORPORATION, Tokyo (JP)

(72) Inventors: Daisuke IIDA, Musashino-shi, Tokyo (JP); Chihiro KITO, Musashino-shi, Tokyo (JP); Yusuke KOSHIKIYA, Musashino-shi, Tokyo (JP)

(73) Assignee: NIPPON TELEGRAPH AND TELEPHONE CORPORATION, Tokyo (JP)

(21) Appl. No.: 18/863,924

(22) PCT Filed: Jun. 20, 2022
(86) PCT No.: PCT/JP2022/024553

§ 371 Date: Nov. 7, 2024

(51) Int. Cl. G01D 5/353; H04B 10/077

(52) U.S. Cl. CPC G01D 5/35358; H04B 10/077

(57) ABSTRACT

According to the present disclosure, provided is an optical fiber sensing system including: a path selection optical switch; an optical test device; and a first optical circulator inserted into an optical fiber targeted for measurement, in which in a situation where communication light goes toward the path selection optical switch, the first optical circulator is utilized for getting the test light entering the optical fiber targeted for measurement, and the path selection optical switch is activated for separating the backscattered light from the communication network, and in a situation where the communication light goes from the path selection optical switch, the path selection optical switch is activated for getting the test light, from the optical test device, entering the optical fiber targeted for measurement, and the first optical circulator is utilized for separating the backscattered light from the communication network.

### TECHNICAL FIELD

The present disclosure relates to estimating a surrounding environment, in which an optical fiber is installed, by utilizing vibration of an optical fiber, for communication, already laid over an urban area.

### BACKGROUND ART

An optical fiber sensing technology using backscattered light of test light has been proposed (See, for example, Non Patent Literature 1). Non Patent Literature 1 discloses an optical measurement technology for observing the state of an optical fiber, where measurement is performed only at one end. Therefore, the measurement technology does not require opposing devices. In Non Patent Literature 1, the test light of pulsed light or continuous light is injected, and the backscattered light, generated by scattering of the test light in an optical fiber, is observed.

A relay optical fiber has an NW (NW: abbreviation of network) configuration in which a path selection optical switch and an optical amplifier for long-distance transmission are used together. As the optical amplifier, an erbium-doped fiber amplifier (EDFA) capable of collectively amplifying a wavelength division multiplexing (WDM) signal is used, and an optical isolator for restricting unidirectional transmission, which is a necessary condition as a characteristic thereof, is used. Therefore, in order to perform bidirectional communication, the relay optical fiber enables reciprocation of communication light with two optical fibers.

Optical fiber sensing using test light as disclosed in Non Patent Literature 1 is based on propagation of backscattered light in a direction opposite to that of the test light through the same optical fiber; therefore, the optical fiber sensing cannot be performed in the relay optical fiber, in which a propagation direction is restricted unidirectionally by an optical isolator.

### CITATION LIST

### Non Patent Literature

Non Patent Literature 1: “Advances in distributed vibration sensing for optical communication fiber state visualization”, Optical Fiber Technology, Vol.57, 102263.

Non Patent Literature 2: NTT Information Network Laboratory Group, “For the first time in the world, communication equipment monitoring technology utilizing vibration sensed by communication optical fiber as a sensor is demonstrated. Grasping environmental information of the city and aiming to utilize it for disaster countermeasures.”, NTT Press Release, https://group.ntt/jp/newsrelease/2021/09/27/210927a.html

### SUMMARY OF INVENTION

### Technical Problem

An object of the present disclosure is to enable optical fiber sensing based on measurement of backscattered light, with respect to an optical path using optical fibers separately corresponding to different communication directions.

### Solution to Problem

An optical fiber sensing system of the present disclosure includes: a path selection optical switch incorporated in a communication network that transmits communication light; an optical test device for emitting test light and receiving backscattered light caused by scattering the test light in an optical fiber, targeted for measurement, in the communication network; and a first optical circulator inserted into the optical fiber targeted for measurement, and executes an optical fiber sensing method of the present disclosure.

In the optical fiber sensing method of the present disclosure, in a situation where the optical fiber targeted for measurement is an optical fiber through which the communication light goes toward the path selection optical switch, the first optical circulator is utilized for getting the test light entering the optical fiber targeted for measurement, and the path selection optical switch is activated for separating the backscattered light from the communication network.

In the optical fiber sensing method of the present disclosure, in a situation where the optical fiber targeted for measurement is an optical fiber through which the communication light goes from the path selection optical switch, the path selection optical switch is activated for getting the test light, from the optical test device, entering the optical fiber targeted for measurement, and the first optical circulator is utilized for separating the backscattered light from the communication network.

There may be provided an optical switch connected to the optical test device, the first optical circulator, and the path selection optical switch, and the optical switch may output the test light from the optical test device to one of the first optical circulator and the path selection optical switch, and output the backscattered light, separated from the other of the first optical circulator and the path selection optical switch, to the optical test device.

In this regard, there may be provided a second optical circulator, having three ports, between the optical switch and the optical test device, and the second optical circulator may emit, to a second port, the backscattered light going from the optical switch and entering a first port, and emit the test light, entering the second port, to the optical switch.

A transmission direction of the communication light through each optical fiber connected to the path selection optical switch may be unidirectional only. In this regard, there may be provided a first optical amplifier for amplifying the communication light entering the path selection optical switch; and a second optical amplifier for amplifying the communication light emitted from the path selection optical switch, and the first optical amplifier may be connected to the first optical circulator, the first optical amplifier, and the path selection optical switch in this order along the transmission direction of the communication light, and the second optical amplifier may be connected to the path selection optical switch, the second optical amplifier, and the first optical circulator in this order along the transmission direction of the communication light.

Note that the disclosures described above can be combined in any possible manner.

### Advantageous Effects of Invention

In the present disclosure, the optical fiber sensing based on measurement of backscattered light can be performed, with respect to an optical path using optical fibers separately corresponding to different communication directions.

### BRIEF DESCRIPTION OF DRAWINGS

FIG. 1 illustrates an example of a network configuration in which a path selection optical switch and an optical amplifier for long-distance transmission are used.

FIG. 2 illustrates a configuration example of an optical fiber sensing system of the present disclosure.

FIG. 3 illustrates an example of optical fiber sensing using a communication optical fiber.

FIG. 4 illustrates a configuration example of an optical fiber sensing system of the present disclosure.

FIG. 5 illustrates a configuration example of an optical fiber sensing system of the present disclosure.

FIG. 6 illustrates a configuration example of an optical fiber sensing system of the present disclosure.

FIG. 7 illustrates a configuration example of an optical fiber sensing system of the present disclosure.

FIG. 8 illustrates a configuration example of an optical fiber sensing system of the present disclosure.

### DESCRIPTION OF EMBODIMENTS

Hereinafter, embodiments of the present disclosure will be described in detail with reference to the drawings. Note that the present disclosure is not limited to the embodiments described below. These examples are merely exemplary, and the present disclosure can be implemented in forms obtained by making various modifications and improvements on the basis of the knowledge of those skilled in the art. Note that components having the same reference numerals in the present specification and the drawings denote the same components.

### Network Configuration

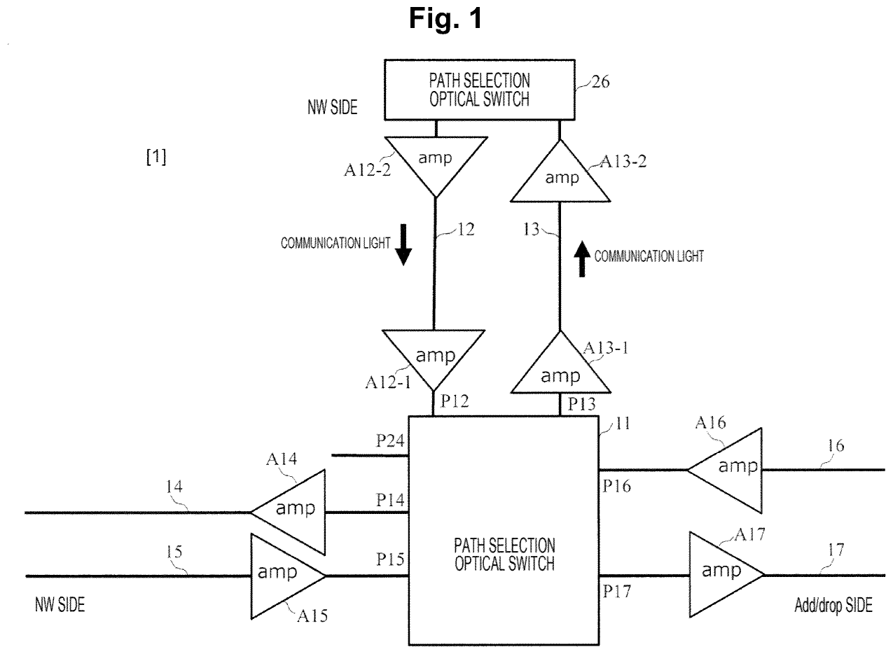

FIG. 1 illustrates an example of a network configuration in which a path selection optical switch and an optical amplifier for long-distance transmission are used. A path selection optical switch 11 is incorporated in a communication network that transmits communication light and has a function of switching a path for communication light, such as a wavelength switch. In the present embodiment, an example is illustrated in which the path selection optical switch 11 connects optical fibers 12 and 13 of a first path on a NW side, optical fibers 14 and 15 of a second path on the NW side, and optical fibers 16 and 17 on an Add/drop side. Optical amplifiers A12-1, A12-2, A13-1, A13-2, A14, A15, A16, and A17 are connected to the optical fibers, separately.

The communication directions of the optical fibers 12 and 13 are different, the communication directions of the optical fibers 14 and 15 are different, and the communication directions of the optical fibers 16 and 17 are different. For example, the path selection optical switch 11 gets communication light, from the optical fiber 12, entering the optical fiber 14 or 17, and gets communication light, from the optical fiber 15, entering the optical fiber 13 or 17. Furthermore, the optical fiber 16 is used for communication in an Add direction applied to the NW. The optical fiber 17 is used for communication in a Drop direction extracted from the NW.

The path selection optical switch 11 includes a plurality of ports for each path, and can switch connection to the ports. In the present embodiment, an example is described in which ports P12 and P13 for connecting to the optical fibers 12 and 13 are set up on the first path side, ports P14 and P15 for connecting to the optical fibers 14 and 15 are set up on the second path side, and ports P17 and P18 for connecting to the optical fibers 16 and 17 are set up on the Add/drop side.

The communication light output from the path selection optical switch 11 to the optical fiber 17 is amplified by the optical amplifier A17. The communication light transmitted through the optical fiber 16 is amplified by the optical amplifier A16 before being input to the path selection optical switch 11. The optical amplifier A16 functions as a first optical amplifier, and the optical amplifier A17 functions as a second optical amplifier.

The optical fibers 12 and 13 are connected to an adjacent path selection optical switch 26. The communication light output from the path selection optical switch 11 to the optical fiber 13 is amplified by the optical amplifier A13-1. The communication light transmitted through the optical fiber 13 is amplified by the optical amplifier A13-2 before being input to the path selection optical switch 26. The communication light output from the path selection optical switch 26 to the optical fiber 12 is amplified by the optical amplifier A12-2. The communication light transmitted through the optical fiber 12 is amplified by the optical amplifier A12-1 before being input to the path selection optical switch 11. With respect to the path selection optical switch 11, the optical amplifier A12-1 functions as the first optical amplifier, and the optical amplifier A13-1 functions as the second optical amplifier. The optical fibers 14 and 15 are also connected to an adjacent path selection optical switch (not illustrated), and have the same configuration as the optical fibers 12 and 13 have.

In the present disclosure, as illustrated in FIG. 1, optical fiber sensing by means of backscattered light measurement can be performed, with respect to a communication optical fiber using two optical fibers reciprocally, using the path selection optical switch and the optical amplifier.

### Outline of Present Disclosure

In the present disclosure, an optical circulator configured for getting a specific wavelength, corresponding to test light, going in a specific direction is inserted outside the optical amplifier A12-1, A13-1, A14, A15, A16, or A17 attached to a port of the path selection optical switch 11.

In the situation of measuring an optical fiber such as the optical fiber 12 through which communication light goes toward the path selection optical switch 11, the test light cannot be input using the path selection optical switch 11, and thus the test light is input to the optical fiber by using the optical circulator. Since the backscattered light returns to the path selection optical switch 11, the backscattered light is extracted, as it is, by the path selection optical switch 11.

In the situation of measuring the optical fiber such as the optical fiber 13 through which the communication light goes from the path selection optical switch 11, the communication light can be input using the path selection optical switch 11, but the backscattered light cannot return to the path selection optical switch 11. Therefore, the backscattered light is extracted using the optical circulator.

As described above, in the present disclosure, using the optical circulator and the path selection optical switch 11 can bring about separation into the communication light, the test light for the fiber sensing, and the backscattered light without causing a loss, and execution of the optical fiber sensing with directional propagation restriction of the optical amplifier avoided.

### First Embodiment

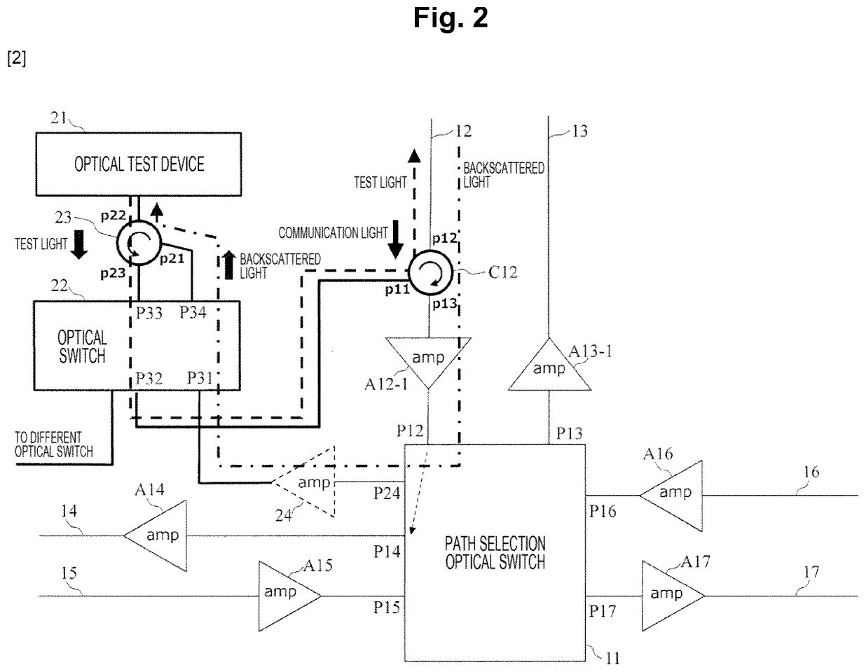

FIG. 2 illustrates a configuration example of an optical fiber sensing system of the present embodiment. The optical fiber sensing system of the present embodiment includes an optical test device 21. The optical test device 21 emits test light and receives backscattered light caused by scattering the test light in the optical fiber.

When disturbance (bending, temperature change, strain, vibration, or the like) is applied to the optical fiber, the state of the optical fiber changes, and the state of the backscattered light also changes with the state change. When the state change of the backscattered light, measured by the optical test device 21, is observed, the state change of the optical fiber can be observed, and the state of the disturbance applied to the optical fiber can be observed. That is, observing the backscattered light by means of an optical fiber installed for communication, regarded as a sensor, can measure/estimate the disturbance (bending, temperature change, strain change, vibration, or the like) applied to the optical fiber. The disturbance that can be measured depends on a measurement method and the type of scattered light to be observed. The present disclosure can adopt any measurement method and observation target to which the optical test device 21 is applicable.

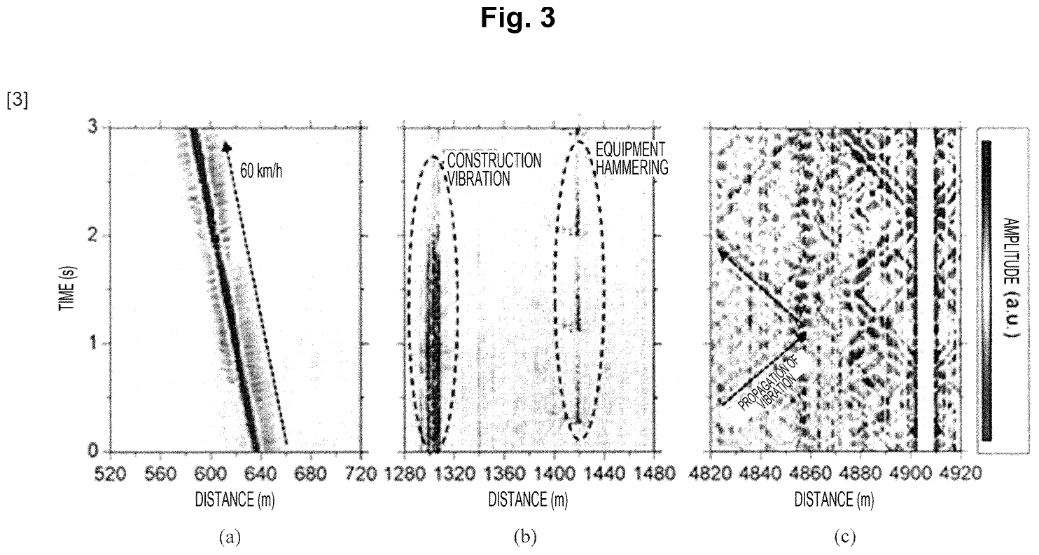

FIG. 3 illustrates an example of the optical fiber sensing using a communication optical fiber (see, for example, Non Patent Literature 2). FIG. 3(a) is an example of vibration propagated through the optical fiber laid under the ground where a vehicle runs. FIG. 3(b) is an example of the vibration propagated through the optical fiber laid under the ground where a worker is performing construction work or equipment inspection. FIG. 3(c) is an example of the vibration of the optical fiber laid, by using a utility pole, in the air where the optical fiber or a closure swings due to wind or the like. As illustrated in FIGS. 3(a) to 3(c), the measurement results determined by the optical test device 21 are different. The communication optical fiber is already laid over an urban area, and the state of the surrounding environment can be estimated by just measuring the communication optical fiber as it is, and information obtained from the estimation can be used for various purposes.

In the present embodiment, an optical circulator C12 is inserted into the optical fiber 12 in order to perform optical fiber sensing on the optical fiber 12. The optical circulator C12 functions as a first optical circulator, and the ports p11, p12, and p13 function as first, second, and third ports, respectively.

The optical fiber sensing system performs the optical fiber sensing method of the present disclosure. In the optical fiber sensing method of the present disclosure, in a situation where the optical fiber targeted for measurement is an optical fiber through which the communication light goes toward the path selection optical switch 11, the optical circulator C12 is utilized for getting the test light entering the optical fiber 12 targeted for measurement, and the path selection optical switch 11 is activated for separating the backscattered light from the communication network.

In the present embodiment, the measurement target is the optical fiber 12. The communication light through the optical fiber 12 is transmitted from the adjacent path selection optical switch toward the path selection optical switch 11. In this regard, the port p11 of the optical circulator C12 is connected to the optical test device 21, and the port p13 of the optical circulator C12 is connected to the path selection optical switch 11.

The optical circulator C12 emits the test light entering the port p11 to the port p12. Thus, the test light enters the optical fiber 12. The backscattered light scattered in the optical fiber 12 enters the port p12 of the optical circulator C12. The optical circulator C12 emits the test light entering the port p12 to the port p13. Thus, the backscattered light enters the path selection optical switch 11. The path selection optical switch 11 emits the backscattered light entering from the optical fiber 12 to a port P24.

As described above, in the present embodiment, the test light enters the port p11 of the optical circulator C12, and the backscattered light returns to the port p12 of the optical circulator C12, goes from the port p13, and enters the path selection optical switch 11. The backscattered light passes through the port P24 of the path selection optical switch 11 and is received by the optical test device 21.

For the sake of a choice between the path selection optical switch 11 and the optical circulator C12, an optical circulator 23 and the optical switch 22 may be used as necessary. The optical circulator 23 functions as a second optical circulator, and the ports p21, p22, and p23 function as first, second, and third ports, respectively.

The test light emitted from the optical test device 21 enters the port p22 of the optical circulator 23 and is emitted from the port p23 of the optical circulator 23. The port p23 of the optical circulator 23 is connected to the optical switch 22, and the test light enters the optical switch 22. On the other hand, the backscattered light from the optical switch 22 enters the port p21 and is emitted from the port p22.

Furthermore, in the present embodiment, the different ports P31 and P32 of the optical switch 22 are connected to the path selection optical switch 11 and the optical circulator C12. The optical switch 22 outputs the test light, input from a port P33, to the port P32, and outputs the backscattered light, input from the port P31, to a port P34. Thus, in the present embodiment, the test light from the port p23 of the optical circulator 23 enters the optical circulator C12, and the backscattered light from the port P24 of the path selection optical switch 11 enters the port p21 of the optical circulator 23. As described above, in the present embodiment, the test light can be transmitted and the backscattered light can be propagated with low loss by using the optical circulator 23 and the optical switch 22.

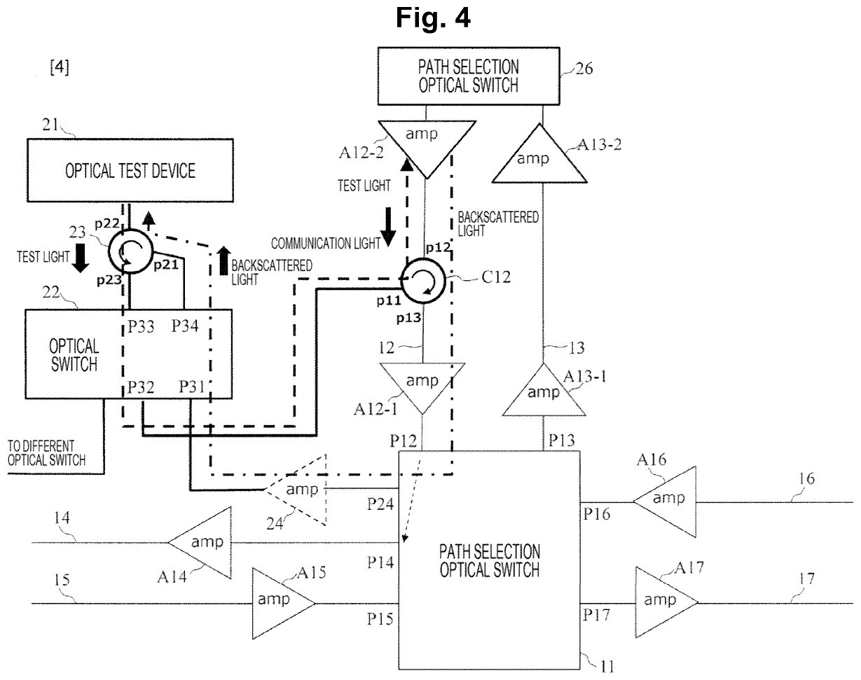

Note that as illustrated in FIG. 4, the optical fibers 12 and 13 may be connected to the path selection optical switch 26 different from the path selection optical switch 11. In this regard, the transmission of the test light can be cut off by the optical amplifier A12-2 on the opposite side.

Provided that the test light and the communication light have different wavelengths, the path selection optical switch 11 having a wavelength selection function may be used. Thus, the communication light and backscattered light can be separated in the path selection optical switch 11, so that the communication and the optical fiber sensing can be performed simultaneously.

Furthermore, the test light and the communication light may have the same wavelength. In this regard, the optical fiber sensing using the test light only needs to be performed at a timing when communication is unperformed through the optical fiber 12 targeted for measurement.

### Second Embodiment

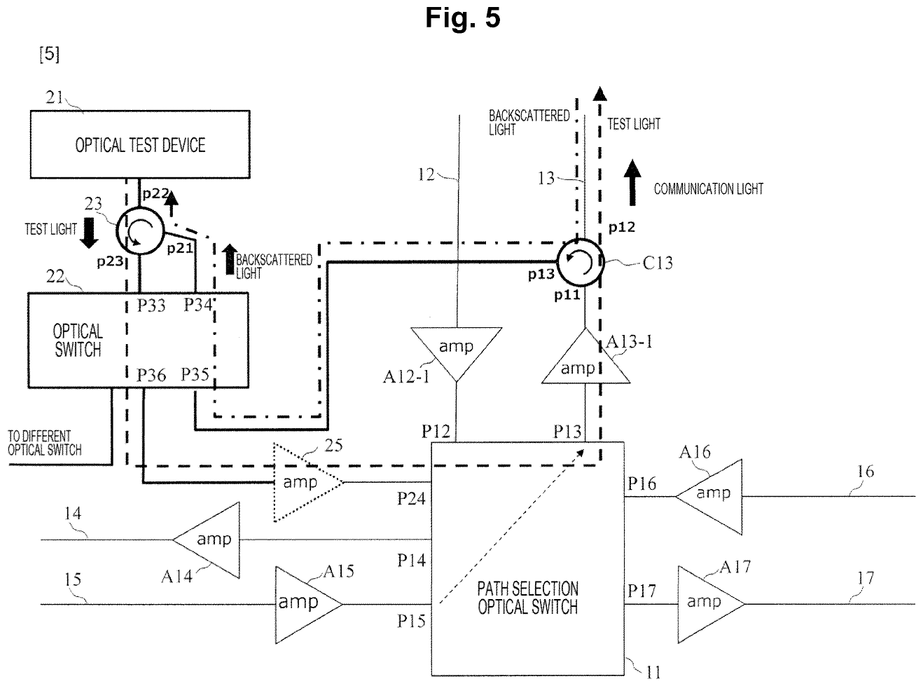

FIG. 5 illustrates a configuration example of the optical fiber sensing system of the present embodiment. In the present embodiment, an optical circulator C13 is inserted into the optical fiber 13 in order to perform optical fiber sensing by means of the optical fiber 13. The optical circulator C13 functions as a first optical circulator, and the ports p11, p12, and p13 function as first, second, and third ports, respectively.

In the present embodiment, the measurement target is the optical fiber 13. The communication light through the optical fiber 13 is transmitted from the path selection optical switch 11 toward the adjacent path selection optical switch. Therefore, the optical fiber targeted for measurement is an optical fiber through which communication light goes from the path selection optical switch 11. In this regard, the port p11 of the optical circulator C13 is connected to the path selection optical switch 11, and the port p13 of the optical circulator C13 is connected to the optical test device 21.

When the test light is input to a freely selected port P24 of the path selection optical switch 11, the path selection optical switch 11 outputs the test light to the optical fiber 13 targeted for measurement. The test light enters the port p11 of the optical circulator C13 and is emitted from the port p12. Thus, the test light enters the optical fiber 13. The backscattered light in the optical fiber 13 returns to the port p12 of the optical circulator C13, is emitted from the port p13, and is received by the optical test device 21.

For the sake of a choice between the path selection optical switch 11 and the optical circulator C13, an optical circulator 23 and the optical switch 22 may be used as necessary. In the present embodiment, different ports P35 and P36 of the optical switch 22 are connected to the optical circulator C13 and the path selection optical switch 11, respectively. The optical switch 22 outputs the test light, input from the port P33, to the port P36, and outputs the backscattered light, input from the port P35, to the port P34. Thus, in the present embodiment, the test light emitted from the port p23 of the optical circulator 23 enters the port P24 of the path selection optical switch 11, and the backscattered light emitted from the optical circulator C13 enters the port p21 of the optical circulator 23. As described above, in the present embodiment, the test light can be transmitted and the backscattered light can be propagated with low loss by using the optical circulator 23 and the optical switch 22.

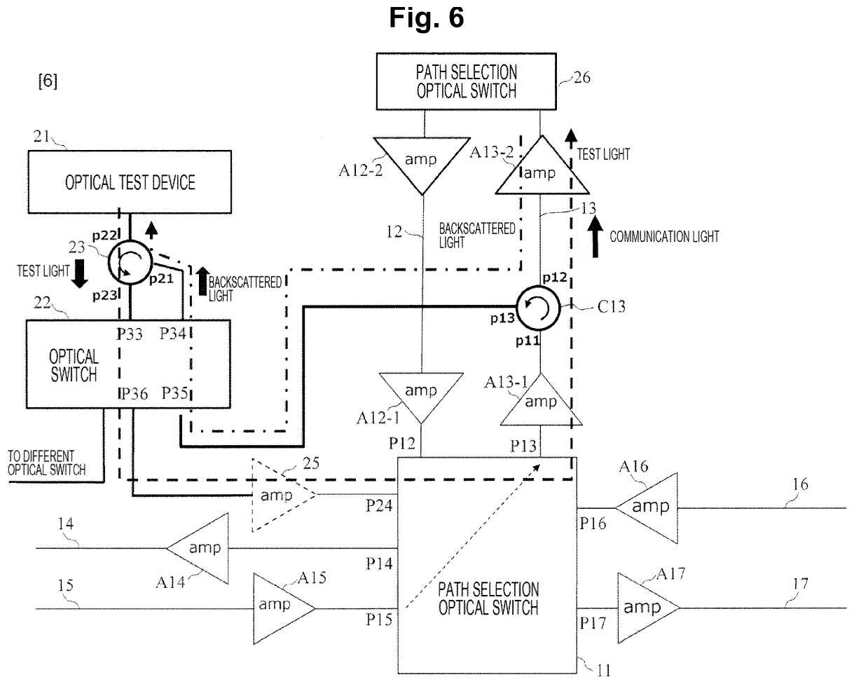

Note that as illustrated in FIG. 6, the optical fibers 12 and 13 may be connected to the path selection optical switch 26 different from the path selection optical switch 11.

Furthermore, the test light and the communication light may have the same wavelength. In this regard, the optical fiber sensing using the test light only needs to be performed at a timing when communication is unperformed through the optical fiber 13 targeted for measurement.

Furthermore, an optical amplifier 25 may be attached to the port P24 of the path selection optical switch 11.

### Third Embodiment

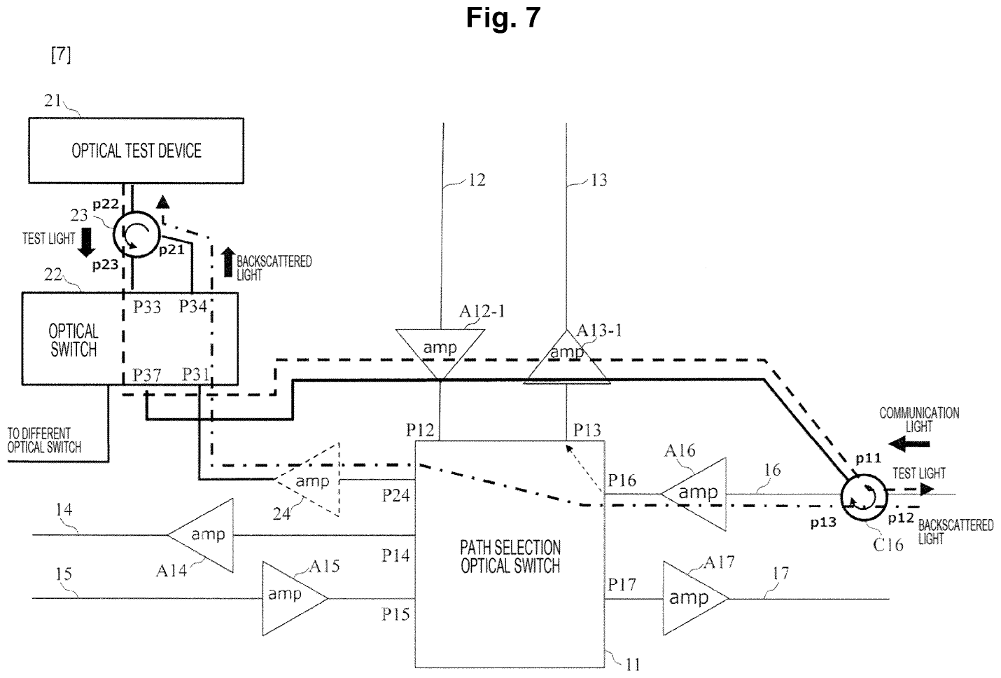

FIG. 7 illustrates a configuration example of the optical fiber sensing system of the present embodiment. In the present embodiment, an optical circulator C16 is inserted into the optical fiber 16 in order to perform optical fiber sensing by means of the optical fiber 16. The optical circulator C16 functions as a first optical circulator, and the ports p11, p12, and p13 function as first, second, and third ports, respectively.

The communication light through the optical fiber 16 is transmitted from a user terminal (not illustrated) toward the path selection optical switch 11. Therefore, the optical fiber targeted for measurement is an optical fiber through which the communication light goes toward the path selection optical switch 11. In this regard, the port p11 of the optical circulator C16 is connected to the optical test device 21, and the port p13 of the optical circulator C16 is connected to the path selection optical switch 11.

The operation of the optical circulator C16 is similar to that of the optical circulator C12 of the first embodiment, provided that the optical fiber 12 is replaced with the optical fiber 16. However, in the present embodiment, the path selection optical switch 11 outputs the backscattered light entering from the optical fiber 16 to the port P24.

In the present embodiment, for the sake of a choice between the path selection optical switch 11 and the optical circulator C16, an optical circulator 23 and the optical switch 22 may be used as necessary. In the present embodiment, the different ports P31 and P37 of the optical switch 22 are connected to the path selection optical switch 11 and the optical circulator C16. The optical switch 22 outputs the test light, input from the port P33, to the port P37, and outputs the backscattered light, input from the port P31, to the port P34. Thus, in the present embodiment, the test light emitted from the port p23 of the optical circulator 23 enters the optical circulator C16, and the backscattered light emitted from the port P24 of the path selection optical switch 11 enters the port p21 of the optical circulator 23. As described above, in the present embodiment, the test light can be transmitted and the backscattered light can be propagated with low loss by using the optical circulator 23 and the optical switch 22.

In addition, provided that the test light and the communication light have different wavelengths, the path selection optical switch 11 having a wavelength selection function may be used. Thus, the communication light and backscattered light can be separated in the path selection optical switch 11, so that the communication and the optical fiber sensing can be performed simultaneously.

Furthermore, the test light and the communication light may have the same wavelength. In this regard, the optical fiber sensing using the test light only needs to be performed at a timing when communication is unperformed through the optical fiber 16 targeted for measurement.

### Fourth Embodiment

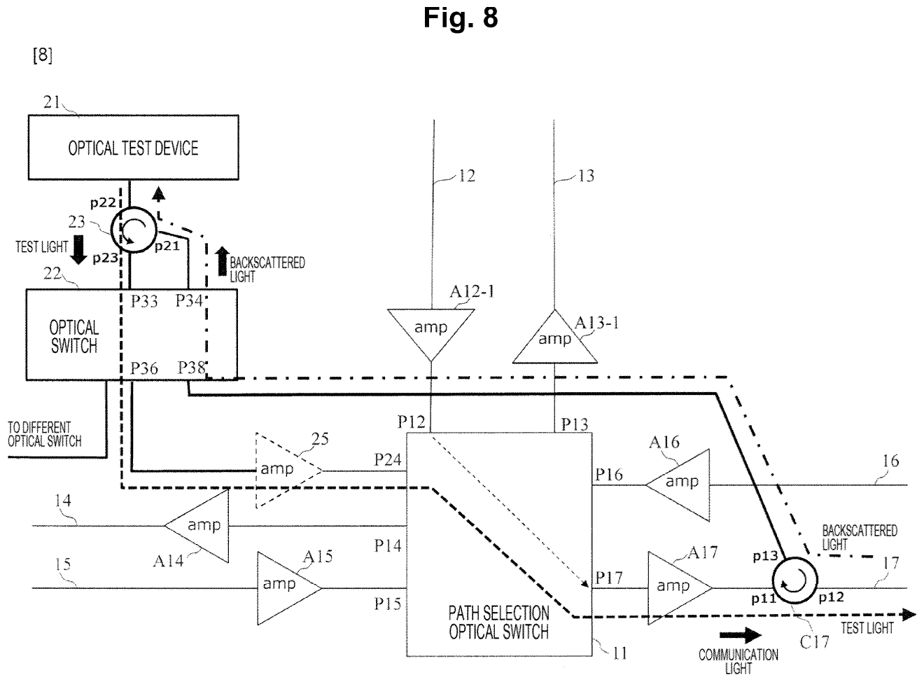

FIG. 8 illustrates a configuration example of the optical fiber sensing system of the present embodiment. In the present embodiment, an optical circulator C17 is inserted into the optical fiber 17 in order to perform optical fiber sensing by means of the optical fiber 17. The optical circulator C17 functions as a first optical circulator, and the ports p11, p12, and p13 function as first, second, and third ports, respectively.

The communication light of the optical fiber 17 is transmitted from the path selection optical switch 11 toward the user terminal (not illustrated). Therefore, the optical fiber targeted for measurement is an optical fiber through which communication light goes from the path selection optical switch 11. In this regard, the port p11 of the optical circulator C17 is connected to the path selection optical switch 11, and the port p13 of the optical circulator C17 is connected to the optical test device 21.

Furthermore, in the present embodiment, the path selection optical switch 11 outputs the test light input to the port P24 to the optical fiber 17. Thus, the test light enters the optical fiber 17 targeted for measurement. The operation of the optical circulator C17 is similar to that of the optical circulator C13 of the second embodiment, provided that the optical fiber 13 is replaced with the optical fiber 17.

In the present embodiment, for the sake of a choice between the path selection optical switch 11 and the optical circulator C17, an optical circulator 23 and the optical switch 22 may be used as necessary. In the present embodiment, the different ports P36 and P38 of the optical switch 22 are connected to the path selection optical switch 11 and the optical circulator C17. The optical switch 22 outputs the test light, input from the port P33, to the port P36, and outputs the backscattered light, input from the port P38, to the port P34. Thus, in the present embodiment, the test light emitted from the port p23 of the optical circulator 23 enters the port P24 of the path selection optical switch 11, and the backscattered light emitted from the port p13 of the optical circulator C17 enters the port p21 of the optical circulator 23. As described above, in the present embodiment, the test light can be transmitted and the backscattered light can be propagated with low loss by using the optical circulator 23 and the optical switch 22.

Furthermore, the test light and the communication light may have the same wavelength. In this regard, the optical fiber sensing using the test light only needs to be performed at a timing when communication is unperformed through the optical fiber 17 targeted for measurement.

Furthermore, an optical amplifier 25 may be attached to the port P24 of the path selection optical switch 11.

### REFERENCE SIGNS LIST

11, 26 Path selection optical switch
12, 13, 14, 15, 16, 17 Optical fiber
A12-1, A12-2, A13-1, A13-2, A14, A15, A16, A17, A24, A25 Optical amplifier
21 Optical test device
22 Optical switch
23, C12, C13, C16, C17 Optical circulator

1. An optical fiber sensing system comprising:
a path selection optical switch incorporated in a communication network that transmits communication light;
an optical test device for emitting test light and receiving backscattered light caused by scattering the test light in an optical fiber, targeted for measurement, in the communication network; and
a first optical circulator inserted into the optical fiber targeted for measurement,
wherein
in a situation where the optical fiber targeted for measurement is an optical fiber through which the communication light goes toward the path selection optical switch,
the first optical circulator is utilized for getting the test light entering the optical fiber targeted for measurement, and
the path selection optical switch is activated for separating the backscattered light from the communication network, and
in a situation where the optical fiber targeted for measurement is an optical fiber through which the communication light goes from the path selection optical switch,
the path selection optical switch is activated for getting the test light, from the optical test device, entering the optical fiber targeted for measurement, and
the first optical circulator is utilized for separating the backscattered light from the communication network.

2. The optical fiber sensing system according to claim 1, comprising an optical switch connected to the optical test device, the first optical circulator, and the path selection optical switch,
wherein the optical switch outputs the test light from the optical test device to one of the first optical circulator and the path selection optical switch, and outputs the backscattered light, separated from the other of the first optical circulator and the path selection optical switch, to the optical test device.

3. The optical fiber sensing system according to claim 2, comprising a second optical circulator, having three ports, between the optical switch and the optical test device,
wherein the second optical circulator emits, to a second port, the backscattered light going from the optical switch and entering a first port, and emits the test light, entering the second port, to the optical switch.

4. The optical fiber sensing system according to claim 1, wherein a transmission direction of the communication light through each optical fiber connected to the path selection optical switch is unidirectional only.

5. The optical fiber sensing system according to claim 4, comprising:
a first optical amplifier for amplifying the communication light entering the path selection optical switch; and
a second optical amplifier for amplifying the communication light emitted from the path selection optical switch,
wherein
the first optical amplifier is connected to the first optical circulator, the first optical amplifier, and the path selection optical switch in this order along the transmission direction of the communication light, and
the second optical amplifier is connected to the path selection optical switch, the second optical amplifier, and the first optical circulator in this order along the transmission direction of the communication light.

6. An optical fiber sensing method executed by an optical fiber sensing system including
a path selection optical switch incorporated in a communication network that transmits communication light,
an optical test device for emitting test light and receiving backscattered light caused by scattering the test light in an optical fiber, targeted for measurement, in the communication network, and
a first optical circulator inserted into the optical fiber targeted for measurement,
the method comprising:
in a situation where the optical fiber targeted for measurement is an optical fiber through which the communication light goes toward the path selection optical switch,
getting the test light entering the optical fiber, targeted for measurement, by utilizing the first optical circulator; and
separating the backscattered light from the communication network by activating the path selection optical switch; and
in a situation where the optical fiber targeted for measurement is an optical fiber through which the communication light goes from the path selection optical switch,
getting the test light, from the optical test device, entering the optical fiber targeted for measurement by activating the path selection optical switch; and
separating the backscattered light from the communication network by utilizing the first optical circulator.
